(19) United States
(12) Patent Application Publication
(10) Pub. No.: US 2005/0173321 A1
(43) Pub. Date: Aug. 11, 2005

(54) Pool filter

(76) Inventor: Jeff Cady, Colleyville, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 10/775,415

(22) Filed: Feb. 10, 2004

(51) Int. Cl. B01D 29/17; B01D 29/085

(52) U.S. Cl. 210/169

(57) ABSTRACT

A filter is disclosed for installation in a pool filter basket. The filter includes a filter screen having an edge, a first band, partially affixed to the filter screen near the edge and partially free, and a second band opposed to the first band, partially affixed to the filter screen near the edge and partially free. The filter is installed by placing the filter screen inside the filter basket, pulling the edge, the first band and the second band over the rim of the filter basket, forming a lip and the first band is pulled across the second band and the second band is pulled across the first band, securing the filter to the filter basket. In an alternative method of installation, the filter screen is placed inside the filter basket, but the free portion of first band and the free portion of the second band are on top of the filter basket, going under a filter basket handle if the filter basket has a handle. The edge, the affixed portion of the first band and the affixed portion of the second band are pulled over the rim of the filter basket, forming a lip. In a preferred form of the filter, the filter screen comprises micro-fiber. In preferred forms, the first and second bands are made of an elastic material or are configured as drawstrings, although they could be some other form, such as strings simply to be tied.

### Background of the Invention

1. Field of the Invention

The present invention relates to pool filters used for swimming pools or hot tubs, and in particular to pool filters which install inside of filter baskets.

2. Description of Related Art

Pool filter baskets, also known as skimmer baskets, have been considered inadequate by themselves. Various filters have been used for placing inside the basket. These filters are typically simple screen material such as nylon and may have an elastic band to place around the outside to hold the filter in place.

### SUMMARY OF THE INVENTION

A filter according to the present invention for installation in a pool filter basket includes a filter screen having an edge, a first band, partially affixed to the filter screen near the edge and partially free, and a second band opposed to the first band, partially affixed to the filter screen near the edge and partially free. The filter is installed by placing the filter screen inside the filter basket, pulling the edge, the first band and the second band over the rim of the filter basket, forming a lip and the first band is pulled across the second band and the second band is pulled across the first band, securing the filter to the filter basket.

In an alternative method of installation, the filter screen is placed inside the filter basket, but the free portion of first band and the free portion of the second band are on top of the filter basket, going under a filter basket handle if the filter basket has a handle. The edge, the affixed portion of the first band and the affixed portion of the second band are pulled over the rim of the filter basket, forming a lip.

In a preferred form of the filter, the filter screen comprises micro-fiber, such as used for surgical masks and nurses caps. In preferred forms, the first and second bands are made of an elastic material or are configured as drawstrings, although they could be some other form, such as strings simply to be tied.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a top front perspective view of a filter according to the present invention;

FIG. 2 is a front view of the filter of FIG. 1 installed in a pool filter basket;

FIG. 3 is a top view of a filter according to the present invention installed in a pool filter basket in an alternative manner; and

FIG. 4 is a top front view of the filter of FIG. 3 being removed from the pool filter basket.

### DESCRIPTION OF THE PREFERRED EMBODIMENT

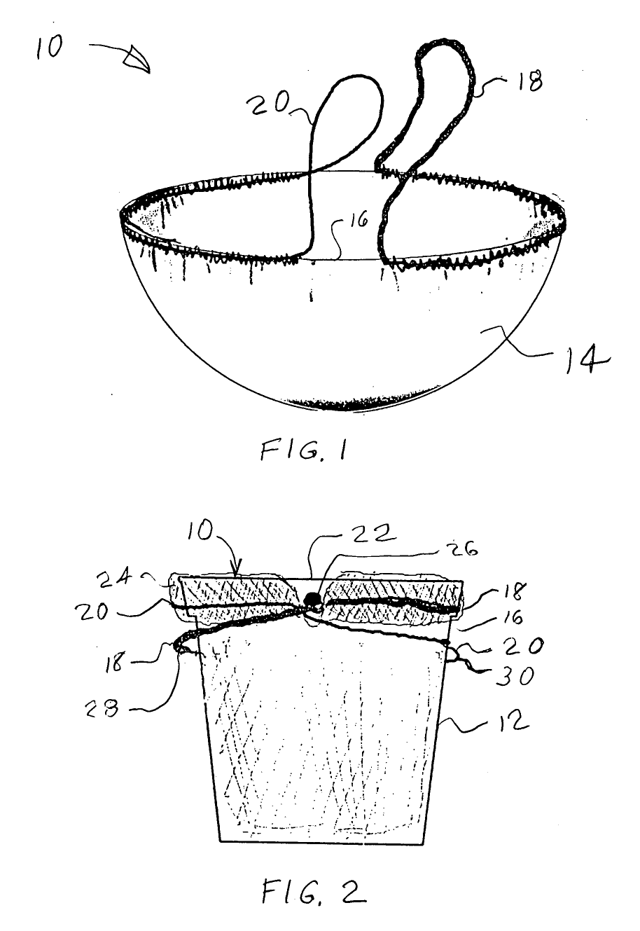

Referring now to the drawing, and in particular to FIG. 1 and FIG. 2, a filter according to the present invention is referred to by reference numeral 10. Filter 10 is for installation in a pool filter basket 12 includes a filter screen 14 having an edge 16, a first band 18, partially affixed to the filter screen near the edge and partially free, and a second band 20 opposed to the first band, partially affixed to the filter screen near the edge and partially free. Filter 10 is installed by placing filter screen 14 inside filter basket 12, pulling edge 16, first band 18 and second band 20 over the rim 22 of the filter basket, forming a lip 24. The first band is pulled across the second band and the second band is pulled across the first band, securing the filter to the filter basket. Using two opposed bands allows the accommodation of a filter basket handle 26, unlike conventional pool filters with a single band which simply must squeeze around the handle, not making a secure installation.

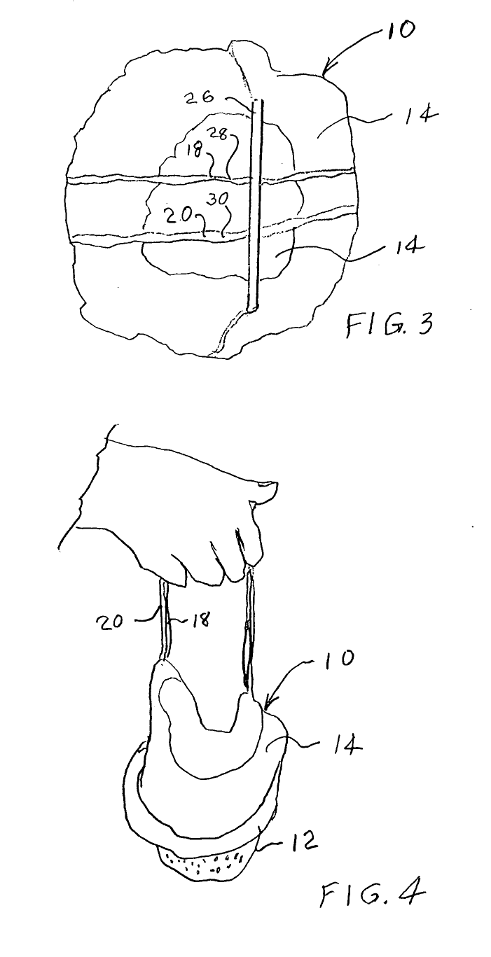

In an alternative method of installation, referring now to FIG. 3 and FIG. 4, filter screen 14 is placed inside filter basket 12, but the free portion 28 of first band 18 and the free portion 30 of the second band 20 are on top of the filter basket, going under filter basket handle 26 if the filter basket has a handle. The edge, the affixed portion of the first band and the affixed portion of the second band are pulled over the rim of the filter basket, forming a lip. In such an arrangement, the free portions of the bands act as a handle. In such an arrangement, when it is time for a user 32 to remove filter 10, then user 32 simply pulls up on free portions 28 and 30 of the bands acting as a handle.

In a preferred form of the filter, the filter screen comprises micro-fiber. In preferred forms, the first and second bands are made of an elastic material or are configured as drawstrings, although they could be some other form, such as strings simply to be tied. If made of elastic material, they should be of a length and strength to firmly secure the filter in the filter basket.

The micro-fiber filters much finer particles that conventional pool filters, but still allows substantial water flow.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A filter for installation in a pool filter basket, comprising in combination:
a filter screen having an edge;
a first band, partially affixed to the filter screen near the edge, wherein the first filter band is partially free; and
a second band, partially affixed to the filter screen near the edge, opposed to the first band, wherein the second filter band is partially free.

2. A filter according to claim 1, wherein the filter screen comprises micro-fiber.

3. A filter according to claim 2, wherein the first band comprises an elastic material and the second band comprises an elastic material.

4. A filter according to claim 2, wherein the first band comprises a drawstring and the second band comprises a drawstring.

5. A filter according to claim 1, wherein the first band comprises an elastic material and the second band comprises an elastic material.

6. A filter according to claim 1, wherein the first band comprises a drawstring and the second band comprises a drawstring.

7. A method for installing a filter into a pool filter basket, wherein the filter comprises a filter screen having an edge, a first band, partially affixed to the filter screen near the edge, wherein the first filter band is partially free and a second band, partially affixed to the filter screen near the edge, opposed to the first band, wherein the second filter band is partially free, comprising the steps of:
placing the filter screen inside the filter basket; and
pulling the edge, the first band and the second band over the rim of the filter basket, forming a lip and the first band is pulled across the second band and the second band is pulled across the first band, securing the filter to the filter basket.

8. A method for installing a filter into a pool filter basket, wherein the filter comprises a filter screen having an edge, a first band, partially affixed to the filter screen near the edge, wherein the first filter band is partially free and a second band, partially affixed to the filter screen near the edge, opposed to the first band, wherein the second filter band is partially free, comprising the steps of:
placing the filter screen inside the filter basket, wherein the free portion of first band and the free portion of the second band are on top of the filter basket, going under a filter basket handle if the filter basket has a handle;
pulling the edge, the affixed portion of the first band and the affixed portion of the second band over the rim of the filter basket, forming a lip.

9. A method for installing a filter into a pool filter basket, wherein the filter comprises a filter screen having an edge, a handle, affixed to the filter screen, comprising the steps of:
placing the filter screen inside the filter basket, wherein the handle is on top of the filter basket, going under a filter basket handle if the filter basket has a handle;
pulling the edge and the affixed portion of the handle over the rim of the filter basket, forming a lip.

10. A filter for installation in a pool filter basket, comprising in combination:
a filter screen having an edge; and
a handle, partially affixed to the filter screen near the edge.

11. A filter according to claim 10, wherein the filter screen comprises micro-fiber.
